(19) United States
(12) Patent Application Publication
(10) Pub. No.: US 2026/0064301 A1
(43) Pub. Date: Mar. 5, 2026

(54) FLASH PARTITION UPGRADE METHOD AND DEVICE, APPATATUS, AND STORAGE NEDIUM

(71) Applicant: Hangzhou Meari Technology Co.,Ltd., Hangzhou (CN)

(72) Inventors: Shihai XIE, Hangzhou (CN); Wei JIN, Hangzhou (CN); Hongli YING, Hangzhou (CN)

(73) Assignee: Hangzhou Meari Technology Co.,Ltd., Hangzhou (CN)

(21) Appl. No.: 19/188,037

(22) Filed: Apr. 24, 2025

(30) Foreign Application Priority Data
Apr. 24, 2024 (CN) 202410497071 .0

(51) Int. Cl. G06F 3/06

(52) U.S. Cl. CPC G06F 3/0644; G06F 3/0607; G06F 3/0659; G06F 3/0679

(57) ABSTRACT

A Flash partition upgrade method and device, an apparatus, and a storage medium, applied to a SquashFS system are provided. The Flash partition upgrade method includes: obtaining available DDR memory information via a kernel command line and Linux; performing virtual partition creation and Flash memory copy based on the available DDR memory information and a preset virtual partition creation rule to obtain a target virtual APP MTD partition and a copy status record identifier corresponding to an APP partition in system Flash; by modifying implementation of a preset readsect function, performing data reading based on the copy status record identifier and the target virtual APP MTD partition to obtain target data; in response to a corresponding APP partition upgrade trigger condition being met, performing partition upgrade based on the target data. In this way, Flash partition upgrade under the condition of limited resources can be effectively achieved.

### CROSS REFERENCE TO THE RELATED APPLICATIONS

This application is based upon and claims priority to Chinese Patent Application No. 202410497071.0, filed on Feb. 24, 2024, the entire contents of which are incorporated herein by reference.

### TECHNICAL FIELD

The present disclosure relates to the field of embedded applications, in particular to a Flash partition upgrade method and device, an apparatus, and a storage medium.

### BACKGROUND

Currently, programs running on SquashFS (a compressed read-only file system used in the Linux kernel) flash memory partitions require updating. An ideal solution involves using ping-pong partitions; however, this is not feasible in resource-constrained embedded systems lacking such resources. Consequently, there is a desire to update the flash partition by relying on the program content that has already been loaded into memory. Yet, at least two issues exist herein. First, according to the execution mechanism of Linux (generally referring to the GNU/Linux operating system) ELF (executable and linkable format) files, when an ELF file is loaded, only the mapping relationship between virtual addresses and the file is established, the content is not fully loaded into memory. Linux relies on a page fault mechanism to load file content on demand, thus, it cannot be guaranteed that all content required for subsequent program execution is already resident in memory. Second, according to the memory management mechanism of Linux, content already loaded into memory is not guaranteed to remain there persistently. Under memory pressure, some loaded memory may be reclaimed, for example, the code segments and ROData segments (an abbreviation for read-only data segments, used for storing read-only data) of user processes are prime candidates for reclamation. In both scenarios, the program may trigger a page fault. Since the original content in the flash has been modified, the currently running program will crash. While the mlock system call (a type of system call function) can be used to mark the program's memory with the PG_locked flag to prevent reclamation, this method still cannot ensure all required content is pre-loaded into memory. Furthermore, in systems already constrained by scarce memory resources, this approach is evidently not advisable.

Therefore, how to achieve Flash partition upgrade under the condition of limited resources is an urgent problem to be solved at present.

### SUMMARY

In view of the above, the objective of the present disclosure is to provide a Flash partition upgrade method and device, an apparatus, and a storage medium, which can effectively achieve Flash partition upgrade under the condition of limited resources, with minimal changes to the SquashFS system, and can be used in cross-departmental collaboration. The specific solution is as follows:

In a first aspect, the present disclosure provides a Flash partition upgrade method, applied to a SquashFS system, including:

obtaining available DDR memory information via a corresponding kernel command line and corresponding Linux;

performing virtual partition creation and Flash memory copy based on the available DDR memory information and a preset virtual partition creation rule to obtain a target virtual APP MTD partition and a copy status record identifier corresponding to an APP partition in system Flash;

by modifying implementation of a preset readsect function, performing data reading based on the copy status record identifier and the target virtual APP MTD partition to obtain corresponding target data;

in response to a corresponding APP partition upgrade trigger condition being met, performing partition upgrade based on the target data to complete an upgrade operation corresponding to the current APP partition.

In some embodiments, the obtaining available DDR memory information through a corresponding kernel command line and corresponding Linux includes:

performing kernel boot using the corresponding kernel command line via universal boot codes to send information on memory resources used by a digital signal processor in the system to the corresponding Linux distribution and then obtain the corresponding available DDR memory information based on the kernel command line.

In some embodiments, the performing virtual partition creation and Flash memory copy based on the available DDR memory information and a preset virtual partition creation rule includes:

creating a corresponding ioctl call, and after successful creation, checking if a memory for the created ioctl call is greater than a memory for the MTD partition corresponding to the APP partition in the system Flash to obtain a corresponding memory determination result; or

by opening a corresponding proc node or mtd node, determining whether a memory for the proc node or the mtd node is greater than the memory for the MTD partition corresponding to the APP partition to obtain the corresponding memory determination result;

in response to the memory determination result of being greater than the memory for the MTD partition corresponding to the APP partition, performing kernel address mapping, Flash content copy, and identifier configuration based on the available DDR memory information to obtain the target virtual APP MTD partition and the copy status record identifier corresponding to the APP partition.

In some embodiments, in response to the memory determination result of being greater than the memory for the MTD partition corresponding to the APP partition, performing kernel address mapping, Flash content copy, and identifier configuration based on the available DDR memory information includes:

in response to the memory determination result of being greater than the memory for the MTD partition corresponding to the APP partition, performing virtual address mapping using ioremap and the available DDR memory information, and copying contents of the APP partition and the MTD partition to corresponding DDR based on the available DDR memory information to obtain the target virtual APP MTD partition after the copy is completed.

In some embodiments, the obtaining a copy status record identifier corresponding to an APP partition in system Flash includes:

during the process of Flash content copy, performing identifier definition and identifier initialization using an atomic_t variable to obtain an initial copy status record identifier;

after obtaining the target virtual APP MTD partition, obtaining a corresponding copy status record identifier that is set to 1.

In some embodiments, by modifying implementation of a preset readsect function, performing data reading based on the copy status record identifier and the target virtual APP MTD partition includes:

by modifying the implementation of the preset readsect function used to read a Flash content in the MTD partition, determining whether the virtual APP MTD partition corresponds to the APP partition to obtain the corresponding partition determination result;

in response to the partition determination result being positive, obtaining the corresponding copy status record identifier, and determining whether a value of the status record identifier is greater than zero to obtain the corresponding identifier determination result;

in response to the identifier determination result that the value of the copy status record identifier is greater than zero, determining whether a sequence number of a target block obtained based on the readsect function belongs to the range of the target virtual APP MTD partition to obtain corresponding numerical determination result;

in response to the numerical determination result that the sequence number of the target block obtained based on the readsect function belongs to the range of the target virtual APP MTD partition, obtaining the corresponding target data from the target virtual MTD partition.

In some embodiments, the Flash partition upgrade method further includes:

in response to the identifier determination result or the numerical determination result being negative, obtaining the target data from the APP partition.

In a second aspect, the present disclosure provides a Flash partition upgrade device, applied to a SquashFS system, including:

a memory information acquisition module configured to obtain available DDR memory information via a corresponding kernel command line and corresponding Linux;

a virtual partition creation module configured to perform virtual partition creation and Flash memory copy based on the available DDR memory information and a preset virtual partition creation rule to obtain a target virtual APP MTD partition and a copy status record identifier corresponding to an APP partition in system Flash;

a data read module configured to, by modifying implementation of a preset readsect function, perform data reading based on the copy status record identifier and the target virtual APP MTD partition to obtain corresponding target data;

a partition upgrade module configured to, in response to a corresponding APP partition upgrade trigger condition being met, perform partition upgrade based on the target data to complete an upgrade operation corresponding to the current APP partition.

In a second aspect, the present disclosure provides an electronic apparatus, including:

a memory configured to store computer programs;

a processor configured to execute the computer programs to implement the steps of the Flash partition upgrade method described above.

In a fourth aspect, the present disclosure provides a computer-readable storage medium, configured to store computer programs, wherein when the computer programs are executed by a processor, the steps of the Flash partition upgrade method described above are implemented As can be seen that in the present disclosure, the corresponding available DDR memory information is obtained via the corresponding kernel command line and the corresponding Linux; virtual partition creation and Flash memory copy are performed based on the available DDR memory information and the preset virtual partition creation rule to obtain the target virtual APP MTD partition and the copy status record identifier corresponding to the APP partition in system Flash; by modifying implementation of the preset readsect function, data reading is performed based on the copy status record identifier and the target virtual APP MTD partition to obtain the corresponding target data; in response to the corresponding APP partition upgrade trigger condition being met, partition upgrade is performed based on the target data to complete the upgrade operation corresponding to the current APP partition. That is, the present disclosure creates the target virtual APP MTD partition using the obtained available DDR memory information, and then modifies the implementation of the preset readsect function to modify the interface of the SquashFS system for reading Flash content so as to read data from the target virtual APP MTD partition. In this way, Flash partition upgrade under the condition of limited resources can be effectively achieved, with minimal changes to the SquashFS system, which can be used in cross-departmental collaboration.

### BRIEF DESCRIPTION OF THE DRAWINGS

To more clearly illustrate the technical solutions of the embodiments of the present disclosure or the prior art, the accompanying drawings used in the technical description are briefly introduced below. Obviously, the drawings in the following description are only the embodiments of the present disclosure. For those skilled in the art, other drawings can be obtained from the provided drawings without creative effort.

FIG. 1 is a flowchart showing a Flash partition upgrade method according to the present disclosure;

FIG. 2 is a flowchart showing a specific Flash partition upgrade method according to the present disclosure;

FIG. 3 is a schematic structural diagram showing a Flash partition upgrade device according to the present disclosure;

FIG. 4 is a schematic structural diagram showing an electronic apparatus according to the present disclosure.

### DETAILED DESCRIPTION OF THE EMBODIMENTS

The technical solutions of the embodiments of the present disclosure will be clearly and completely described below with reference to the accompanying drawings. Obviously, the described embodiments are only a part of the embodiments of the present disclosure, but not all of the embodiments. Based on the embodiments of the present disclosure, all other embodiments obtained by those skilled in the art without creative effort are within the scope of protection of the present disclosure.

Currently, in some embedded application fields, the system's Flash resources and DDR (double data rate synchronous dynamic random access memory) are very limited. When Flash resources are sufficient, ping-pong partitioning can be considered. The method involves burning the updated image file to another ping-pong partition, but in resource-constrained systems, there is no spare Flash resources to support this approach. In addition, there's a method of dividing the programs into several parts and then upgrading only the part that needs upgrading to create a dynamic library, which allows for upgrades through dynamic library overriding. The drawback is that while the read-only SquashFS file system cannot be used, the greater cost is the need to make significant adjustments to the existing program structure. It is also difficult to promote cooperation that involves multiple departments.

To this end, the present disclosure provides a Flash partition upgrade method that can effectively achieve Flash partition upgrade under limited resource conditions.

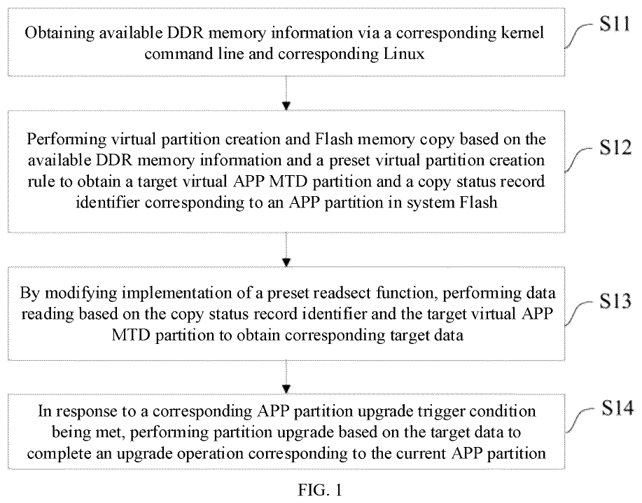

Referring to FIG. 1, the embodiment of the present disclosure discloses a Flash partition upgrade method, applied to a SquashFS system, including:

Step S11, obtaining available DDR memory information via a corresponding kernel command line and corresponding Linux.

Specifically, in this embodiment, the obtaining available DDR memory information via a corresponding kernel command line and corresponding Linux includes: performing kernel boot using the corresponding kernel command line via universal boot codes to send information on memory resources used by a digital signal processor in the system to the corresponding Linux distribution and then obtain the corresponding available DDR memory information based on the kernel command line. This allows to obtain an address and a length of the DDR released by the DSP (digital signal processing). The information on the memory resources used by the DSP is provided by U-Boot (universal boot loader, a bootloader primarily used in embedded systems, also known as the universal boot code. The kernel command line is passed to Linux via cmdline. After Linux boots, it reads proc/cmdline to select a segment and define a data structure to store it:

typedef struct_reserved_mtd_mem_info{

unsigned long addr;

unsigned long len;

}reserved_mtd_mem_info;

Step S12: performing virtual partition creation and Flash memory copy based on the available DDR memory information and a preset virtual partition creation rule to obtain a target virtual APP MTD partition and a copy status record identifier corresponding to an APP partition in system Flash.

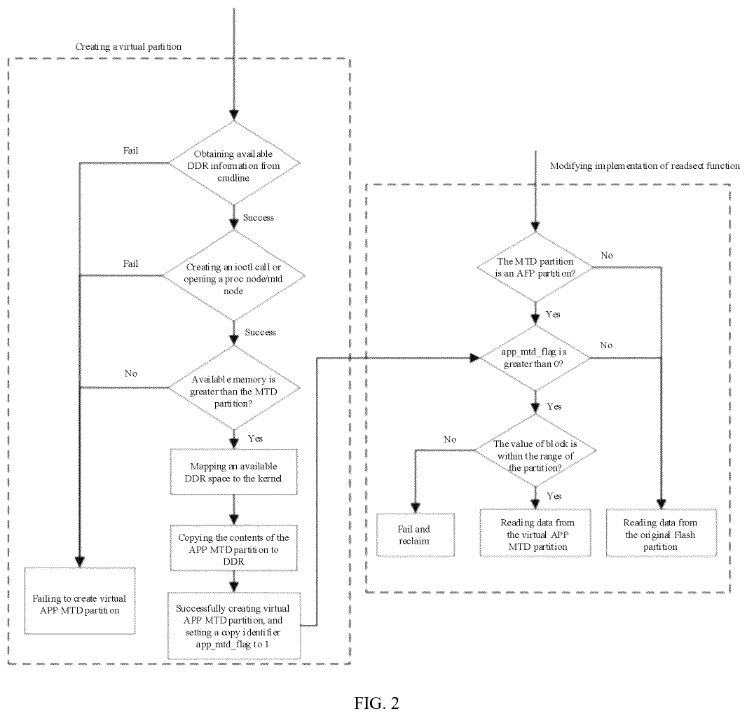

Specifically, as shown in FIG. 2, in this embodiment, the performing virtual partition creation and Flash memory copy based on the available DDR memory information and a preset virtual partition creation rule includes:

creating a corresponding ioctl call, and after successful creation, and checking if a memory for the created ioctl call is greater than a memory for the MTD partition corresponding to the APP partition in the system Flash to obtain a corresponding memory determination result; or by opening a corresponding proc node or mtd node, determining whether a memory for the proc node or the mtd node is greater than the memory for the MTD partition corresponding to the APP partition to obtain the corresponding memory determination result; in response to the memory determination result of being greater than the memory for the MTD partition corresponding to the APP partition, performing kernel address mapping, Flash content copy, and identifier configuration based on the available DDR memory information to obtain the target virtual APP MTD partition and the copy status record identifier corresponding to the APP partition. In this way, a virtual APP MTD partition is thus created. Accordingly, the interaction between applications and the kernel directly utilizes the existing proc/mtd node. Only one ioctl call needs to be added.

Furthermore, in this embodiment, in response to the memory determination result of being greater than the memory for the MTD partition corresponding to the APP partition, performing kernel address mapping, Flash content copy, and identifier configuration based on the available DDR memory information includes: in response to the memory determination result of being greater than the memory for the MTD partition corresponding to the APP partition, performing virtual address mapping using ioremap and the available DDR memory information, and copying contents of the APP partition and the MTD partition to corresponding DDR based on the available DDR memory information to obtain the target virtual APP MTD partition after the copy is completed.

It should be understood that in this embodiment, in order to avoid reading data from memory before the content of Flash has been completely copied into memory, an app_mtd_flag is defined using a kernel's atomic_t variable to record the copy status. This variable is used to ensure the atomicity of the operation, that is, to obtain the copy status record identifier corresponding to the APP partition in the system Flash, including: during the process of Flash content copy, performing identifier definition and identifier initialization using an atomic_t variable to obtain an initial copy status record identifier; after obtaining the target virtual APP MTD partition, obtaining a corresponding copy status record identifier that is set to 1. Specifically, app_mtd_flag can be initialized to 0 by the statement ‘Atomic_t app_mtd_flag=ATOMIC_INIT(0)’.

Furthermore, in this embodiment, if the available DDR information fails to be obtained, the proc node/mtd node fails to open, or the ioctl call fails to create, or the memory determination result of being not greater than the memory for the MTD partition corresponding to the APP partition, it means that the virtual partition creation has failed. Once failure is confirmed, no further steps will be taken.

Step S13: by modifying implementation of a preset readsect function, performing data reading based on the copy status record identifier and the target virtual APP MTD partition to obtain corresponding target data.

Specifically, in this embodiment, by modifying implementation of a preset readsect function, performing data reading based on the copy status record identifier and the target virtual APP MTD partition includes: by modifying the implementation of the preset readsect function used to read a Flash content in the MTD partition, determining whether the virtual APP MTD partition corresponds to the APP partition to obtain the corresponding partition determination result; in response to the partition determination result being positive, obtaining the corresponding copy status record identifier, and determining whether a value of the status record identifier is greater than zero to obtain the corresponding identifier determination result; in response to the identifier determination result that the value of the copy status record identifier is greater than zero, determining whether a sequence number of a target block (i.e., block in FIG. 2) obtained based on the readsect function belongs to the range of the target virtual APP MTD partition to obtain corresponding numerical determination result; in response to the numerical determination result that the sequence number of the target block obtained based on the readsect function belongs to the range of the target virtual APP MTD partition, obtaining the corresponding target data from the target virtual MTD partition. In this way, the contents in the Flash partition can be modified in any way without affecting the operation of the APP. Moreover, when the APP encounters a page fault interruption (the page to be accessed is not in the main memory and the operating system needs to load it into the main memory before accessing it), it will no longer read the contents from the original Flash partition, ensuring a higher success rate of reading.

In addition, in this embodiment, the Flash partition upgrade method further includes: in response to the identifier determination result or the numerical determination result being negative, obtaining the target data from the APP partition.

Step S14: in response to a corresponding APP partition upgrade trigger condition being met, performing partition upgrade based on the target data to complete an upgrade operation corresponding to the current APP partition.

Specifically, in this embodiment, when an upgrade is required, the partition upgrade is performed based on the obtained target data. Furthermore, after upgrading the APP partition, the system is restarted at the appropriate time, and the APP program will run after the update.

In summary, this embodiment provides a Flash partition upgrade method under the condition of limited resources, utilizing. According to the method, the existing resources released when the APP partition needs to be upgraded are utilized, so no additional resources are needed. Since most of modifications are made to the kernel, requiring minimal modifications to the original system, especially to the App, the method is simple, effective, and easy to implement across departments.

As can be seen that in the present disclosure, the corresponding available DDR memory information is obtained via the corresponding kernel command line and the corresponding Linux; virtual partition creation and Flash memory copy are performed based on the available DDR memory information and the preset virtual partition creation rule to obtain the target virtual APP MTD partition and the copy status record identifier corresponding to the APP partition in system Flash; by modifying implementation of the preset readsect function, data reading is performed based on the copy status record identifier and the target virtual APP MTD partition to obtain the corresponding target data; in response to the corresponding APP partition upgrade trigger condition being met, partition upgrade is performed based on the target data to complete the upgrade operation corresponding to the current APP partition. That is, the present disclosure creates the target virtual APP MTD partition using the obtained available DDR memory information, and then modifies the implementation of the preset readsect function to modify the interface of the SquashFS system for reading Flash content so as to read data from the target virtual APP MTD partition. In this way, Flash partition upgrade under the condition of limited resources can be effectively achieved, with minimal changes to the SquashFS system, which can be used in cross-departmental collaboration.

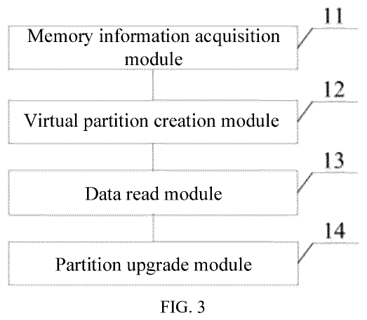

Referring to FIG. 3, the embodiment of the present disclosure further discloses a Flash partition upgrade device, applied to a SquashFS system, including:

A memory information acquisition module 11 configured to obtain available DDR memory information via a corresponding kernel command line and corresponding Linux;

a virtual partition creation module 12 configured to perform virtual partition creation and Flash memory copy based on the available DDR memory information and a preset virtual partition creation rule to obtain a target virtual APP MTD partition and a copy status record identifier corresponding to an APP partition in system Flash;

a data read module 13 configured to, by modifying implementation of a preset readsect function, perform data reading based on the copy status record identifier and the target virtual APP MTD partition to obtain corresponding target data;

a partition upgrade module 14 configured to, in response to a corresponding APP partition upgrade trigger condition being met, perform partition upgrade based on the target data to complete an upgrade operation corresponding to the current APP partition.

For more specific details regarding the operation process of each of the above modules, please refer to the corresponding descriptions disclosed in the foregoing embodiments, which are not repeated herein.

As can be seen that the present disclosure creates the target virtual APP MTD partition using the obtained available DDR memory information, and then modifies the implementation of the preset readsect function to modify the interface of the SquashFS system for reading Flash content so as to read data from the target virtual APP MTD partition. In this way, Flash partition upgrade under the condition of limited resources can be effectively achieved, with minimal changes to the SquashFS system, which can be used in cross-departmental collaboration.

In some embodiments, the memory information acquisition module 11 may specifically include:

A memory information acquisition unit configured to perform kernel boot using the corresponding kernel command line via universal boot codes to send information on memory resources used by a digital signal processor in the system to the corresponding Linux distribution and then obtain the corresponding available DDR memory information based on the kernel command line.

In some embodiments, the virtual partition creation module 12 may specifically include:

A first memory determination unit configured to create a corresponding ioctl call, and after successful creation, check if a memory for the created ioctl call is greater than a memory for the MTD partition corresponding to the APP partition in the system Flash to obtain a corresponding memory determination result;

A second memory determination unit configured to, by opening a corresponding proc node or mtd node, determine whether a memory for the proc node or the mtd node is greater than the memory for the MTD partition corresponding to the APP partition to obtain the corresponding memory determination result;

A virtual partition creation unit configured to, in response to the memory determination result of being greater than the memory for the MTD partition corresponding to the APP partition, perform kernel address mapping, Flash content copy, and identifier configuration based on the available DDR memory information to obtain the target virtual APP MTD partition and the copy status record identifier corresponding to the APP partition.

In some embodiments, the virtual partition creation unit may specifically include:

A virtual partition creation subunit configured to, in response to the memory determination result of being greater than the memory for the MTD partition corresponding to the APP partition, perform virtual address mapping using ioremap and the available DDR memory information, and copy contents of the APP partition and the MTD partition to corresponding DDR based on the available DDR memory information to obtain the target virtual APP MTD partition after the copy is completed.

In some embodiments, the Flash partition upgrade device may specifically include:

An identifier initialization unit configured to, during the process of Flash content copy, perform identifier definition and identifier initialization using an atomic_t variable to obtain an initial copy status record identifier;

An identifier setting unit configured to, after obtaining the target virtual APP MTD partition, obtain a corresponding copy status record identifier that is set to 1.

In some embodiments, the data read module 13 may specifically include:

A partition determination unit configured to, by modifying the implementation of the preset readsect function used to read a Flash content in the MTD partition, determine whether the virtual APP MTD partition corresponds to the APP partition to obtain the corresponding partition determination result;

An identifier determination unit configured to, in response to the partition determination result being positive, obtain the corresponding copy status record identifier, and determining whether a value of the status record identifier is greater than zero to obtain the corresponding identifier determination result;

A numerical determination unit configured to determine, in response to the identifier determination result that the value of the copy status record identifier is greater than zero, determining whether a sequence number of a target block obtained based on the readsect function belongs to the range of the target virtual APP MTD partition to obtain corresponding numerical determination result;

A first data acquisition unit configured to, in response to the numerical determination result that the sequence number of the target block obtained based on the readsect function belongs to the range of the target virtual APP MTD partition, obtain the corresponding target data from the target virtual MTD partition.

In some embodiments, the Flash partition upgrade device may further include:

A second data acquisition unit configured to, in response to the identifier determination result or the numerical determination result being negative, obtain the target data from the APP partition.

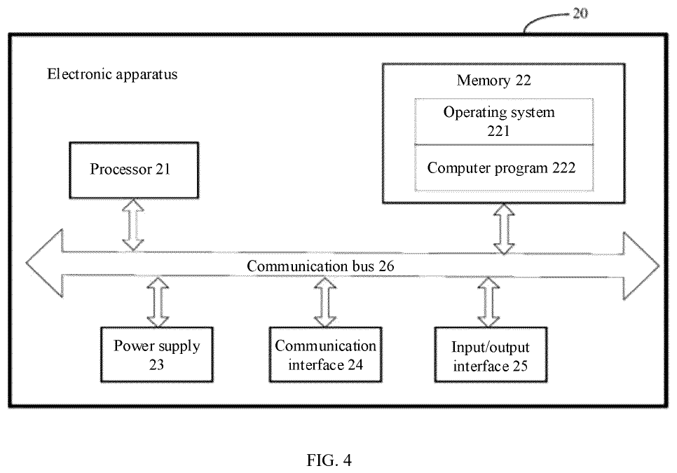

Furthermore, the embodiment of the present disclosure further discloses an electronic apparatus. FIG. 4 is a schematic structural diagram showing an electronic apparatus 2/30 according to an exemplary embodiment. The content of the diagram should not be considered as any limitation on the scope of use of the present disclosure.

FIG. 4 is a schematic structural diagram showing an electronic apparatus 2/30 according to an exemplary embodiment. The electronic apparatus 2/30 may specifically include: at least one processor 2/31, at least one memory 2/32, a power supply 2/33, a communication interface 2/34, an input/output interface 2/35, and communication bus 2/36. The memory 2/32 is configured to store computer programs. The computer programs are loaded and executed by the processor 2/31 to implement the relevant steps of the Flash partition method disclosed in any of the foregoing embodiments. Furthermore, in this embodiment, the electronic apparatus 2/30 may specifically be an electronic computer.

In this embodiment, the power supply 2/33 is configured to provide operation voltage to various hardware devices of the electronic apparatus 2/30; the communication Interface 2/34 enables electronic apparatus 2/30 to create a data transmission channel with external devices, following any communication protocol applicable to the technical solution of the present disclosure, and no specific limitation is imposed here; the input/output interface 2/35 is configured to acquire external input data or output data to the outside world. Its specific interface type can be determined according to the specific application requirements, which is not limited herein.

In addition, the memory 2/32, as a carrier for resource storage, may be a read-only memory, random access memory, disk, or optical disc, etc., and may contain resources such as an operating system (2/321), computer programs (2/322), etc., and the storage method may be either temporary or permanent storage.

The operating system 2/321 is configured to manage and control the various hardware devices on the electronic apparatus 2/30 and the computer programs 2/322, which may be Windows Server, Netware, Unix, Linux, etc. The computer programs 2/322 may include, in addition to computer programs capable of performing the Flash partitioning method executed by the electronic apparatus 2/30 as disclosed in any of the foregoing embodiments, computer programs that can be used to perform other specific tasks.

Furthermore, the present disclosure further discloses a computer-readable storage medium configured to computer programs. When the computer programs executed by a processor, the aforementioned Flash partitioning method is implemented. The specific steps of the method can be referred to the corresponding content disclosed in the foregoing embodiments, which are not repeated herein.

The various embodiments in the specification are described in a progressive manner. Each embodiment focuses on highlighting the differences from the other embodiments. The same or similar parts among different embodiments can be referred to. For the devices disclosed in the embodiments, since they correspond to the disclosed methods, the description is relatively simple. The relevant parts can be referred to in the method section for explanation.

Those skilled in the art can also further realize that, by combining the various units and algorithm steps described in the embodiments disclosed in the present disclosure, they can be implemented using electronic hardware, computer software, or a combination thereof. To clearly illustrate the interchangeability of hardware and software, the above description has generally described the composition and steps of each embodiment in terms of functionality. Whether these functions are executed in the form of hardware or software depends on the specific application and design constraints of the technical solution. Those skilled in the art can use different methods to implement the described functions for each specific application, but such implementation should not be considered to exceed the scope of the present disclosure.

The steps of the methods or algorithms described in the embodiments disclosed in the present disclosure can be implemented directly by hardware, software modules executed by a processor, or a combination thereof. The software modules can be placed in random access memory (RAM), memory, read-only memory (ROM), electrically programmable ROM, electrically erasable programmable ROM, registers, hard disks, removable disks, CD-ROMs, or any other form of storage medium known in the technical field.

Finally, it should be noted that in this article, terms such as first and second are merely used to distinguish one entity or operation from another, and do not necessarily imply or suggest any actual relationship or sequence between these entities or operations. Moreover, the terms “including”, “comprising”, or any of their variations mean to cover non-exclusive inclusion, thereby enabling a process, method, item, or device that includes a series of elements to not only include those elements but also include other elements not explicitly listed, or even include inherent elements of such a process, method, item, or device. Without additional restrictions, the elements limited by the sentence “including one.” are not excluded from existing in other identical elements in the process, method, item, or device that includes the elements.

The above provides a detailed introduction to the technical solution provided by the present disclosure. In the present disclosure, specific embodiments have been used to explain the principle and implementation methods of the present disclosure. The explanations of the above embodiments are merely intended to help understand the method and core idea of the present disclosure; meanwhile, for those having ordinary skills in the art, based on the idea of the present disclosure, there will be changes in specific implementation methods and application scope. In conclusion, the content of this specification should not be construed as a limitation of the present disclosure.

What is claimed is:

1. A Flash partition upgrade method, applied to a SquashFS system, comprising:
obtaining available DDR memory information via a corresponding kernel command line and corresponding Linux;
performing virtual partition creation and Flash memory copy based on the available DDR memory information and a preset virtual partition creation rule to obtain a target virtual APP MTD partition and a copy status record identifier corresponding to an APP partition in system Flash;
by modifying implementation of a preset readsect function, performing data reading based on the copy status record identifier and the target virtual APP MTD partition to obtain corresponding target data; and
in response to a corresponding APP partition upgrade trigger condition being met, performing partition upgrade based on the target data to complete an upgrade operation corresponding to the current APP partition.

2. The Flash partition upgrade method according to claim 1, wherein the obtaining available DDR memory information through the corresponding kernel command line and the corresponding Linux comprises:
performing kernel boot using the corresponding kernel command line via universal boot codes to send information on memory resources used by a digital signal processor in the SquashFS system to the corresponding Linux distribution and then obtain the corresponding available DDR memory information based on the kernel command line.

3. The Flash partition upgrade method according to claim 1, wherein the performing virtual partition creation and Flash memory copy based on the available DDR memory information and the preset virtual partition creation rule comprises:
creating a corresponding ioctl call, and after successful creation, checking if a memory for the ioctl call is greater than a memory for a MTD partition corresponding to the APP partition in the system Flash to obtain a corresponding memory determination result; or
by opening a corresponding proc node or mtd node, determining whether a memory for the proc node or the mtd node is greater than the memory for the MTD partition corresponding to the APP partition to obtain the corresponding memory determination result;
in response to the memory determination result of being greater than the memory for the MTD partition corresponding to the APP partition, performing kernel address mapping, Flash content copy, and identifier configuration based on the available DDR memory information to obtain the target virtual APP MTD partition and the copy status record identifier corresponding to the APP partition.

4. The Flash partition upgrade method according to claim 3, wherein in response to the memory determination result of being greater than the memory for the MTD partition corresponding to the APP partition, performing kernel address mapping, Flash content copy, and identifier configuration based on the available DDR memory information comprises:
in response to the memory determination result of being greater than the memory for the MTD partition corresponding to the APP partition, performing virtual address mapping using ioremap and the available DDR memory information, and copying contents of the APP partition and the MTD partition to corresponding DDR based on the available DDR memory information to obtain the target virtual APP MTD partition after the copy is completed.

5. The Flash partition upgrade method according to claim 1, wherein the obtaining the copy status record identifier corresponding to the APP partition in the system Flash comprises:
during a process of Flash content copy, performing identifier definition and identifier initialization using an atomic_t variable to obtain an initial copy status record identifier; and
after obtaining the target virtual APP MTD partition, obtaining a corresponding copy status record identifier that is set to 1.

6. The Flash partition upgrade method according to claim 1, wherein by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

7. The Flash partition upgrade method according to claim 6, further comprising:
in response to the identifier determination result or the numerical determination result being negative, obtaining the target data from the APP partition.

8. A Flash partition upgrade device, applied to a SquashFS system, comprising:
a memory information acquisition module configured to obtain available DDR memory information via a corresponding kernel command line and corresponding Linux;
a virtual partition creation module configured to perform virtual partition creation and Flash memory copy based on the available DDR memory information and a preset virtual partition creation rule to obtain a target virtual APP MTD partition and a copy status record identifier corresponding to an APP partition in system Flash;
a data read module configured to, by modifying implementation of a preset readsect function, perform data reading based on the copy status record identifier and the target virtual APP MTD partition to obtain corresponding target data; and
a partition upgrade module configured to, in response to a corresponding APP partition upgrade trigger condition being met, perform partition upgrade based on the target data to complete an upgrade operation corresponding to the current APP partition.

9. An electronic apparatus, comprising:
a memory configured to store computer programs;
a processor configured to execute the computer programs to implement the Flash partition upgrade method according to claim 1.

10. A computer-readable storage medium, configured to store computer programs, wherein when the computer programs are executed by a processor, the Flash partition upgrade method according to claim 1 is implemented.

11. The Flash partition upgrade method according to claim 2, wherein by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

12. The Flash partition upgrade method according to claim 3, wherein by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

13. The Flash partition upgrade method according to claim 4, wherein by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

14. The Flash partition upgrade method according to claim 5, wherein by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

15. The electronic apparatus according to claim 9, wherein in the Flash partition upgrade method, the obtaining available DDR memory information through the corresponding kernel command line and the corresponding Linux comprises:
performing kernel boot using the corresponding kernel command line via universal boot codes to send information on memory resources used by a digital signal processor in the SquashFS system to the corresponding Linux distribution and then obtain the corresponding available DDR memory information based on the kernel command line.

16. The electronic apparatus according to claim 9, wherein in the Flash partition upgrade method, the performing virtual partition creation and Flash memory copy based on the available DDR memory information and the preset virtual partition creation rule comprises:
creating a corresponding ioctl call, and after successful creation, checking if a memory for the ioctl call is greater than a memory for a MTD partition corresponding to the APP partition in the system Flash to obtain a corresponding memory determination result; or
by opening a corresponding proc node or mtd node, determining whether a memory for the proc node or the mtd node is greater than the memory for the MTD partition corresponding to the APP partition to obtain the corresponding memory determination result;
in response to the memory determination result of being greater than the memory for the MTD partition corresponding to the APP partition, performing kernel address mapping, Flash content copy, and identifier configuration based on the available DDR memory information to obtain the target virtual APP MTD partition and the copy status record identifier corresponding to the APP partition.

17. The electronic apparatus according to claim 16, wherein in the Flash partition upgrade method, in response to the memory determination result of being greater than the memory for the MTD partition corresponding to the APP partition, performing kernel address mapping, Flash content copy, and identifier configuration based on the available DDR memory information comprises:
in response to the memory determination result of being greater than the memory for the MTD partition corresponding to the APP partition, performing virtual address mapping using ioremap and the available DDR memory information, and copying contents of the APP partition and the MTD partition to corresponding DDR based on the available DDR memory information to obtain the target virtual APP MTD partition after the copy is completed.

18. The electronic apparatus according to claim 9, wherein in the Flash partition upgrade method, the obtaining the copy status record identifier corresponding to the APP partition in the system Flash comprises:
during a process of Flash content copy, performing identifier definition and identifier initialization using an atomic_t variable to obtain an initial copy status record identifier; and
after obtaining the target virtual APP MTD partition, obtaining a corresponding copy status record identifier that is set to 1.

19. The electronic apparatus according to claim 9, wherein in the Flash partition upgrade method, by modifying implementation of the preset readsect function, performing data reading based on the copy status record identifier and the target virtual APP MTD partition comprises:
by modifying the implementation of the preset readsect function used to read a Flash content in the MTD partition, determining whether the virtual APP MTD partition corresponds to the APP partition to obtain the corresponding partition determination result;
in response to the partition determination result being positive, obtaining the corresponding copy status record identifier, and determining whether a value of the status record identifier is greater than zero to obtain the corresponding identifier determination result;
in response to the identifier determination result that the value of the copy status record identifier is greater than zero, determining whether a sequence number of a target block obtained based on the readsect function belongs to a range of the target virtual APP MTD partition to obtain a corresponding numerical determination result; and
in response to the numerical determination result that the sequence number of the target block obtained based on the readsect function belongs to the range of the target virtual APP MTD partition, obtaining the corresponding target data from the target virtual APP MTD partition.

20. The electronic apparatus according to claim 19, wherein the Flash partition upgrade method further comprises:
in response to the identifier determination result or the numerical determination result being negative, obtaining the target data from the APP partition.
